(19) United States
(12) Patent Application Publication
(10) Pub. No.: US 2008/0273006 A1
(43) Pub. Date: Nov. 6, 2008

(54) COLOR-ZONE LAYOUT OF LIGHT-EMITTING MODULE AND CONTROLLING METHOD OF COLOR SEQUENCE

(75) Inventor: Jion-Iou Hong, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/031,705

(22) Filed: Feb. 15, 2008

Related U.S. Application Data
(63) Continuation-in-part of application No. 11/864,920, filed on Sep. 29, 2007.

(30) Foreign Application Priority Data
May 3, 2007 (TW) 96115709

(51) Int. Cl. G09G 3/36; G02F 1/1335

(52) U.S. Cl. 345/102; 349/106

(57) ABSTRACT

A color-zone layout of light-emitting module includes at least a light-emitting zone unit. The light-emitting zone unit includes a plurality of blocks, which are divided into a first color-zone, a second color-zone, a third color-zone and a fourth color-zone. A fifth color-zone is located between any two adjacent ones of the color-zones. The five color-zones simultaneously display within a display frame.

### CROSS-REFERENCE TO RELATED APPLICATION

This application is a continuation-in-part of a prior U.S. application Ser. No. 11/864,920, filed on Sep. 29, 2007, which claims the priority benefit of Taiwan application serial no. 96115709, filed on May 3, 2007. The entirety of the above-mentioned patent applications is hereby incorporated by reference herein and made a part of this specification.

### BACKGROUND OF THE INVENTION

1. Field of the Invention

The present invention generally relates to a light-emitting module, and more particularly, to a backlight module for displays.

2. Description of Related Art

A passive flat display, such as a liquid crystal display (LCD), requires. a backlight module as the light source thereof, and the image data are generated by the pixels of the LCD panel. In general, a pixel is composed of three sub-pixels, for example, of a red sub-pixel, a green sub-pixel and a blue sub-pixel (RGB primary colors). By respectively controlling the luminance gray levels of red color, green color and blue color, a desired mixed color is obtained. The display mechanism herein is, for example, using a backlight module to produce white light in association with RGB color filters respectively disposed on the three sub-pixels to form the red, green and blue sub-pixels.

FIG. 1 is a diagram of pixel arrangement on a conventional LCD panel. Referring to FIG. 1, the image resolution herein is, for example, N×M, there are M scan lines in horizontal direction and 3N pieces of pixel data in vertical direction. A pixel 100 is composed of three RGB sub-pixels, thus, each of the three RGB sub-pixels occupies a portion of space, which wastes the display area.

The above-mentioned spatial display mechanism uses color filters to display frames, which not only wastes more cost but also makes the display luminance of each pixel darker due to the low optical transmittance of the color filter. In addition, the three color filters in red R, green G and blue B are adjacently disposed to each other, which may cause color-blending problem. A conventional solution is provided that a black matrix is disposed between any two adjacent color filters for separating the filters. Although the solution is helpful to lighten the color-blending problem, it also reduces the luminance.

In order to solve the problems of low optical transmittance and color-blending caused by the above-mentioned spatial display mechanism with employed color filters, an LCD taking color-sequencing mode is provided. A time-sharing display mechanism is used in the LCD to produce colors, wherein the mechanism is based on visual persistence effect of human eyes. In terms of the 60 Hz display frequency and the spatial display mechanism of FIG. 1, three RGB sub-pixels of each pixel would simultaneously produce the corresponding display luminance. With the time-sharing display mechanism for producing colors however, three color gray levels are produced by the same pixel, but at three different time points for producing the corresponding RGB gray levels. For example, three RGB gray levels are produced in 180 Hz, so that in a period corresponding to 60 Hz, three color images are sequentially produced so as to make visual persistence effect superposed to virtually produce a desired color image.

The above-mentioned LCD is based on the time-sharing display mechanism without color filters, where the backlight module thereof provides three backlight sources producing red light R, green light G and blue light B. By means of the visual persistence effect of human eyes, the three backlight sources for red light R, green light G and blue light B are fast switched in a time axis, so that after the backlight sources transmit the light through an electrode glass onto each pixel of the LCD panel, the human eyes are able to see blended colors.

FIG. 2 is a diagram of pixel arrangement subject to time-sharing display mechanism on a conventional LCD panel. Referring to FIG. 2, an individual pixel 102 displays three images of R, G and B in different time points, then the three color images are superposed in a short moment to produce a desired color based on the visual persistence effect.

With the above-mentioned LCD taking color-sequencing mode, due to random movement of human eyes or eye instinct of tracing moving objects within a frame, during sequentially accepting a red image, a green image and a blue image, the human eyes may move a little bit, which makes the different color fields of an object not fall on a same position of the retina, so that a color field separation phenomenon at the edge of the object is visually sensed by the human eyes. Moreover, at any time point, the RGB backlight sources only display one color by one color, thus, the produced luminance is one third of the backlight sources only.

FIG. 3 is a diagram of conventional frames subject to special display mechanism. Referring to FIG. 3, in a display period of 1/60 sec. i.e. 60 Hz, a displayed frame contains RGB data created by M scan lines, which is corresponding to RGB images 104. Usually, the frame further includes a blank area 106.

FIG. 4 is a diagram of conventional frames subject to time-sharing display mechanism. Referring to FIG. 4, since the time-sharing display mechanism needs to respectively and completely display the red image, the green image and the blue image, thus, three sub-frames with a period of 1/180 sec. are used, wherein the period superposition of the three sub-frames is equal to 1/60 seconds.

Comparing FIG. 3 with FIG. 4, assuming the area of a pixel for FIG. 3 and FIG. 4 is the same, the conventional color-sequencing mode has at least two shortages: a color field separation phenomenon is unavoidable; the real luminance is one third of the total luminance capacity of the backlight source since at any time only one color of the backlight is displayed, wherein a frame is divided into three sub-frames, therefore, the luminance is ⅓×(⅓+⅓+⅓)=⅓.

In order to solve the color field separation phenomenon, another conventional display mode is provided, where between each set of color sequences a full black frame is inserted for improving the color field separation phenomenon. FIG. 5 is another diagram of conventional frames subject to timed display mechanism. Referring to FIG. 5, the backlight module sequentially in the time axis provides red light R, green light G and blue light B. Considering the inserted a black frame BK, a real color sequence is red R, green G, blue B and black BK, wherein a frame takes 1/60 sec. and each sub-frame takes 1/240 sec.

Although the above-mentioned mode can reduce the color field separation phenomenon, but it makes the luminance further reduced, wherein by using a color sequence of R, G, B and BK, a frame is divided into four sub-frames so that a real luminance is ¼×(⅓+⅓+⅓+0)=¼.

In order to increase the luminance, a further display mode is provided, where, instead of full black frame, a white frame W is inserted so as to make the luminance 1.5 times as high as the previous mode, but the color field separation phenomenon is remained. FIG. 6 is a further diagram of conventional frames subject to time-sharing display mechanism. Referring to FIG. 6, a backlight module sequentially in the time axis provides red light R, green light G and blue light B plus additional white frame so as to make the color sequence become red R, green G, blue B and white W.

By using the color sequence control mode of R, G, B and W, a frame is divided into four sub-frames, therefore, a real luminance is ¼(⅓+⅓+⅓+1)=½. In other words, the luminance is increased to (½)/(⅓)= 3/2.

In general, the above-mentioned conventional display modes are unable to both solve the color field separation phenomenon and increase the display luminance.

### SUMMARY OF THE INVENTION

Accordingly, the present invention is directed to a color-zone layout of a light-emitting module capable of simultaneously solving the color field separation phenomenon and increasing the display luminance.

The present invention is also directed to a controlling method of color sequence for controlling the color-zone layout of a light-emitting module and capable of simultaneously solving the color field separation phenomenon and increasing the display luminance.

The present invention provides a color-zone layout of a light-emitting module, which includes at least a light-emitting zone unit. The light-emitting zone unit includes a plurality of blocks and the blocks are divided into a first color-zone, a second color-zone, a third color-zone, a fourth color-zone and a fifth color-zone, wherein the fifth color-zone is dispersedly disposed between any two adjacent ones of the above-mentioned four color-zones and all the five color-zones are simultaneously displayed within a same display frame.

According to an embodiment of the present invention, in the above-mentioned color-zone layout of a light-emitting module, the light-emitting zone unit includes 20 blocks, and by sequentially and cyclically counting the blocks in a direction from any one of the 20 blocks up, every four continuously arranged blocks respectively form the first color-zone, the second color-zone, the third color-zone and the fourth color-zone. In addition, a block is disposed between adjacent two of the above-mentioned four color-zones and the block is serving as the fifth color-zone.

According to an embodiment of the present invention, in the above-mentioned color-zone layout of a light-emitting module, for example, the first color-zone, the second color-zone, the third color-zone and the fourth color-zone are respectively red, green, blue and white, and the fifth color-zone is black color-zone.

According to an embodiment of the present invention, in the above-mentioned color-zone layout of a light-emitting module, for example, the first color-zone, the second color-zone, the third color-zone and the fourth color-zone are respectively yellow, cyan, magenta and white, and the fifth color-zone is black color-zone.

According to an embodiment of the present invention, in the above-mentioned color-zone layout of a light-emitting module, for example, at least a light-emitting zone unit has a plurality of light-emitting zone units adjacently arranged.

According to an embodiment of the present invention, in the above-mentioned color-zone layout of a light-emitting module, for example, at least a light-emitting zone unit is formed by five light-emitting zone units arranged continuously, wherein the two blocks of the fifth color-zone respectively located in two adjacent light-emitting zone units are shifted from each other by a block.

The present invention further provides a color-zone layout of a light-emitting module, which includes at least a light-emitting zone unit. The light-emitting zone unit includes a plurality of blocks and the blocks are, from any one block up, sequentially and cyclically arranged in a direction into a first color block, a second color block, a third color block, a fourth color block and a fifth color block, and so on, wherein the five color blocks include a black block and a white block.

According to an embodiment of the present invention, in the above-mentioned color-zone layout of a light-emitting module, the light-emitting zone unit includes 20 blocks, which are, from any one block up, sequentially and cyclically arranged in a direction into a first color block, a second color block, a third color block, a fourth color block and a fifth color block, and so on.

According to an embodiment of the present invention, in the above-mentioned color-zone layout of a light-emitting module, for example, the first color block, the second color block, the third color block, the fourth color block and the fifth color block are respectively red, green, blue, white and black.

According to an embodiment of the present invention, in the above-mentioned color-zone layout of a light-emitting module, for example, the first color block, the second color block, the third color block, the fourth color block and the fifth color block are respectively yellow, cyan, magenta, white and black.

According to an embodiment of the present invention, in the above-mentioned color-zone layout of a light-emitting module, for example, at least a light-emitting zone unit has a quantity of five.

The present invention also provides a controlling method of color sequence for controlling the color sequence of a backlight module. The method includes: dividing the backlight module into a plurality of regions; defining the regions into a first light-emitting pattern, a second light-emitting pattern, a third light-emitting pattern, a fourth light-emitting pattern and a fifth light-emitting pattern, wherein each of the light-emitting patterns includes a first color-zone, a second color-zone, a third color-zone, a fourth color-zone and a fifth color-zone. The fifth color-zone separates the first color-zone, the second color-zone, the third color-zone and the fourth color-zone from each other. The light-emitting patterns sequentially and cyclically lighten in a light-emitting cycle of the first light-emitting pattern, the second light-emitting pattern, the third light-emitting pattern, the fourth light-emitting pattern and the fifth light-emitting pattern, wherein the five light-emitting patterns are designed to allow each of the light-emitting patterns to emit the color light of the first color-zone, the color light of the second color-zone, the color light of the third color-zone, the color light of the fourth color-zone and the color light of the fifth color-zone once each after completing the light-emitting cycle.

According to an embodiment of the present invention, in the above-mentioned controlling method of color sequence, the total area of each of the five color-zones is equal to each other or not entirely equal to each other.

According to an embodiment of the present invention, in the above-mentioned controlling method of color sequence, the first color-zone, the second color-zone, the third color-zone and the fourth color-zone are, for example, respectively red, green, blue and white, and the fifth color-zone is black zone.

According to an embodiment of the present invention, in the above-mentioned controlling method of color sequence, the first color-zone, the second color-zone, the third color-zone and the fourth color-zone are, for example, respectively yellow, cyan, magenta and white, and the fifth color-zone is black zone.

According to an embodiment of the present invention, in the above-mentioned controlling method of color sequence, the first light-emitting pattern, the second light-emitting pattern, the third light-emitting pattern, the fourth light-emitting pattern and the fifth light-emitting pattern are formed, for example, by dividing an original pattern into five equal portions and making the portions cyclically shifted.

According to an embodiment of the present invention, in the above-mentioned controlling method of color sequence, the original pattern includes, for example, at least a light-emitting zone unit; the light-emitting zone unit includes 20 blocks; the blocks are sequentially and cyclically counted in a direction from any one of the 20 blocks up; every four continuous blocks respectively form a first color-zone, a second color-zone, a third color-zone and a fourth color-zone, and any two adjacent color-zones are separated by a block; the blocks for separation form a fifth color-zone.

According to an embodiment of the present invention, in the above-mentioned controlling method of color sequence, the first color-zone, the second color-zone, the third color-zone and the fourth color-zone are, for example, respectively red, green, blue and white, and the fifth color-zone is black zone.

According to an embodiment of the present invention, in the above-mentioned controlling method of color sequence, the first color-zone, the second color-zone, the third color-zone and the fourth color-zone are, for example, respectively yellow, cyan, magenta and white, and the fifth color-zone is black zone.

According to an embodiment of the present invention, in the above-mentioned controlling method of color sequence, for example, at least a light-emitting zone unit has a plurality of light-emitting zone units adjacently arranged.

According to an embodiment of the present invention, in the above-mentioned controlling method of color sequence, for example, at least a light-emitting zone unit is formed by five light-emitting zone units arranged continuously, wherein the two blocks of the fifth color-zone respectively located in two adjacent light-emitting zone units are shifted from each other by a block.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of pixel arrangement on a conventional LCD panel.

FIG. 2 is a diagram of pixel arrangement subject to timed display mechanism on a conventional LCD panel.

FIG. 3 is a diagram of conventional frames subject to special display mechanism.

FIG. 4 is a diagram of conventional frames subject to timed display mechanism.

FIG. 5 is another diagram of conventional frames subject to timed display mechanism.

FIG. 6 is a further diagram of conventional frames subject to timed display mechanism.

FIG. 7 is a diagram of frames of a backlight module according to the present invention.

FIG. 8 is a diagram of the color zone patterns of a light-emitting module according to an embodiment of the present invention.

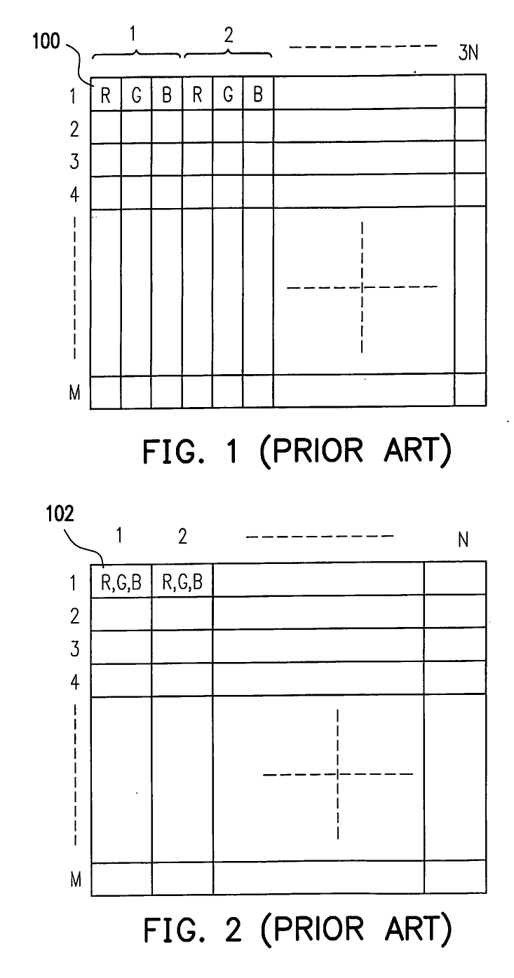

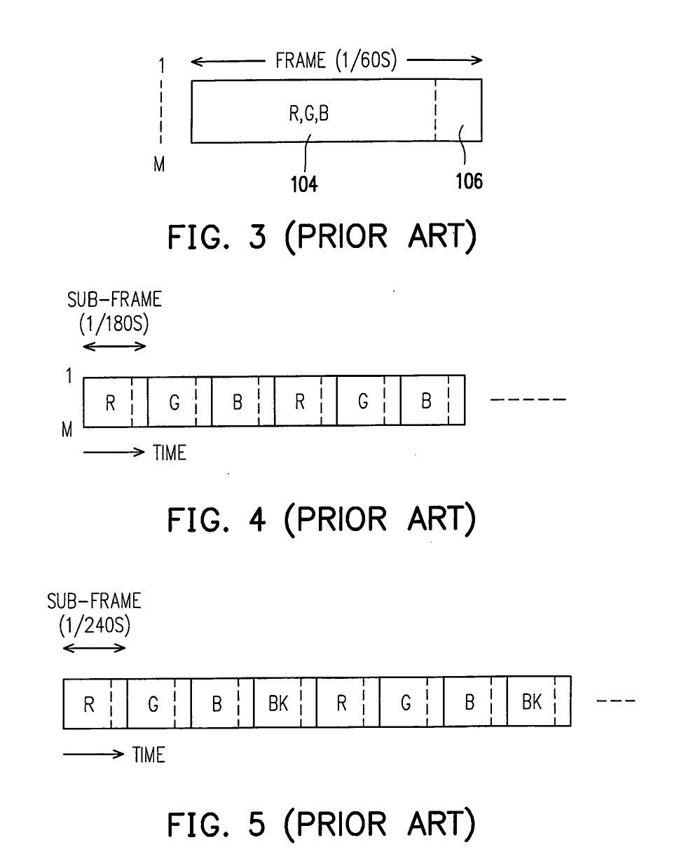

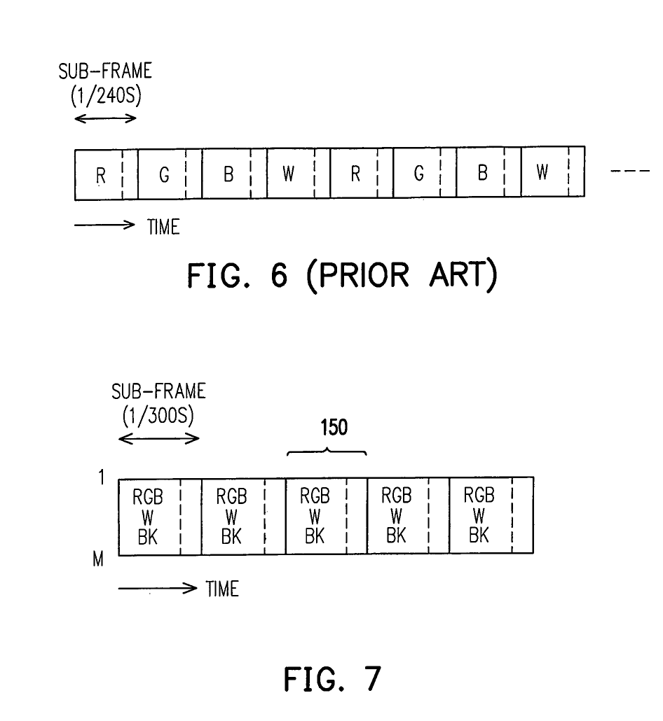

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Due to the research and development of light-emitting components, a light-emitting component today, for example, a light-emitting diode (LED) is able to emit red light, blue light and green light to be blended into white light, or to emit yellow, cyan light and magenta light required by CMY color gamut. Since a light-emitting component has tiny size, so that a plurality of light-emitting components can be arranged to form a light-emitting region. By means of the above-mentioned features of light-emitting components, the present invention provides a light-emitting module composed of light-emitting components applicable to, for example, an LCD as a backlight module. A light-emitting module herein is divided into a plurality of blocks to form a plurality of color-zones, for example, five color-zones of red, blue, green, white and black or five color-zones of yellow, cyan, magenta, white and black. In addition, the present invention further adopts a mechanism to control the pixels of the display panel for displaying the image gray levels of the corresponding colors. In this way, a sub-frame would simultaneously display the five color-zones, which not only increases the luminance, but also lightens the color field separation phenomenon. In the following, some embodiments of the present invention, but not limited by the present invention, are depicted. In particular, the described embodiments can be combined with each other for implements.

FIG. 7 is a diagram of frames of a backlight module according to the present invention. Referring to FIG. 7, the present invention makes a frame divided into five sub-frames 150, wherein a sub-frame 150 takes 1/300 sec. Each of the five color-zones has the same total area and the five color-zones simultaneously emit, for example, red light (R), green light (G), blue light (B), white light (W) and black light (BK). The red color-zone, green color-zone, blue color-zone, and white color-zone herein, for example, respectively occupy a single region, but the black color-zone is dispersedly disposed in portions and each portion thereof is located between the above-mentioned two different color-zones for separation. The black light means full black light without radiation or with a luminance of zero. The five sub-frames 150 respectively have a color-zone pattern, which are obtained by using a designed pattern, and sequentially and cyclically shifting the pattern in a direction (five sub-frames 150 is counted as a cycle) for sequential displays. After the displays of the five sub-frames 150, every pixel therein would emit red light, green light, blue light, white light and black light once each, wherein the red light, the green light and the blue light are for producing image colors, the white light is for increasing the luminance and the black light is for reducing the color field separation phenomenon.

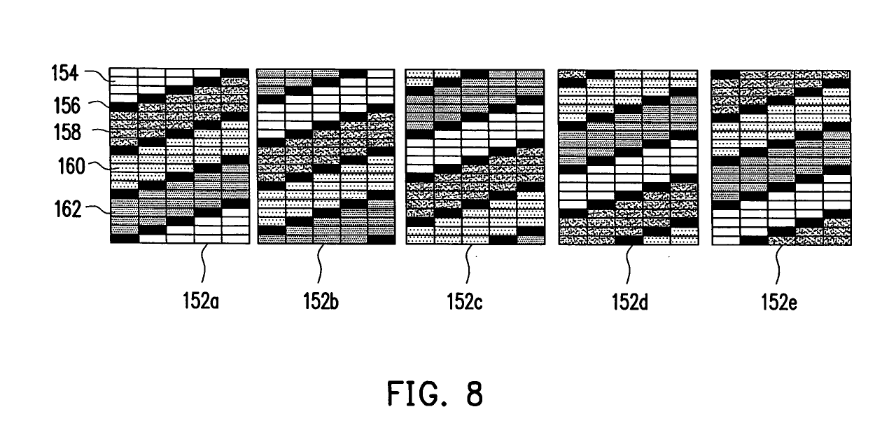

A proper layout of the five color-zones is the key to produce the above-mentioned effects. FIG. 8 is a diagram of the color zone patterns of a light-emitting module according to an embodiment of the present invention. Referring to FIG. 8, in association with the display mechanism of FIG. 7, fire sub-frame patterns in total are needed, i.e. 152a, 152b, 152c, 152d and 152e. Since a sub-frame requires a red color-zone, a green color-zone, a blue color-zone and a white color-zone, and the color-zones need to be separated from each other by a black color-zone, thus, it is divided into 20 blocks. In addition, a light-emitting module is divided into at least a light-emitting zone unit. As shown by FIG. 8, the pattern 152a is preferably divided into five light-emitting zone units located at five adjacent columns. However, in general speaking, at least a light-emitting zone unit is allowed. A less number of the light-emitting zone units may degrade the display effect.

Taking a light-emitting zone unit as an example, a light-emitting zone unit includes, for example, 20 blocks. From anyone block within the 20 blocks up, for example, from the first block of the light-emitting zone unit located at the first column up, every four continuous block in a direction respectively form four color-zones 154, 158, 160 and 162. The block to separate two adjacent color-zones is counted as a fifth color-zone 156, which is, for example, a black block, while the other four color-zones respectively have a various combination of red, green, blue and white. Taking the light-emitting zone unit located at the second column as an example, it is counted from the sixth block up and begins with the color-zone 158.

To achieve more even effect, the embodiment takes the light-emitting zone unit located at the first column as the base, between the two adjacent columns it is shifted by a block, therefore, after the shifts of the five columns, the recycled pattern can be seen as the original pattern but with a down shift of five blocks, i.e. the recycled pattern is almost the same as the original pattern. In the embodiment, only the block blocks are serving as a separation color-zone and disposed dispersedly, while other color-zones take a continuous form.

After forming a pattern 152a by using the above-mentioned scheme, for example, the pattern 152a is taken as a reference pattern. By cyclically down shifting the reference pattern by four blocks, other four patterns 152b, 152c, 152d and 152e are obtained. Once completing the cycle of the five patterns, each block respectively displays red, green, blue, white and black once each, so as to produce the image colors by the triple primary colors red, green and blue; the white is for increasing luminance and the black is for reducing the color field separation phenomenon.

Although it is preferred to sequentially display the patterns 152a, 152b, 152c, 152d and 152e, but in fact, no specific display sequence is required.

In terms of a light-emitting zone unit occupying one column only, the layout of FIG. 8 is not only one choice. Instead, every five blocks form a set and are respectively assigned by red, green, blue, white and black as a color combination, then, the five blocks are sequentially and cyclically arranged, wherein although the black blocks are not for separating each of the red, green, blue and white colors, but the layout also produces a different effect. The pattern of FIG. 8 is a preferable embodiment, not the only choice.

In other words, the five color-zones basically includes a first color-zone, a second color-zone, a third color-zone, a black color-zone and a white color-zone, wherein the first, second and third color-zones can be blended to form various visual colors. In the above-mentioned embodiment, each color-zone has the same total area as the other color-zones. However, each color-zone is allowed to be different from each other, for example, the blocks of the red color-zone have a larger area, the blocks of the blue color-zone have a smaller area, the blocks of the white color-zone have a larger area and the blocks of the black color-zone have a smaller area, and so on, so that the frame appears more red and brighter. The area of each color-zone can be adjusted to suit the preference of individual user. As to the layout of 20 blocks to form a basic unit having five equal-area color-zones evenly arranged is preferable but not the only choice of the present invention.

Since the present invention uses inserted black frames to effectively distinguish different color-zones, thus the present invention is able to reduce indistinct regions and lighten the color field separation phenomenon. In addition, the additional white frame effectively increases the luminance by 20%. By using the controlling mode of color sequence of R, G, B, W and BK colors, since a frame is divided into five sub-frames, thus, the luminance is ⅕×(⅓+⅓+⅓+1+0)=⅕, in other words, the luminance is increased to (⅕)(⅓)= 6/5.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color-zone layout of light-emitting module, comprising:
at least a light-emitting zone unit having a plurality of blocks, wherein the blocks are divided into four different color-zones of a first color-zone, a second color-zone, a third color-zone and a fourth color-zone; a fifth color-zone is disposed between any adjacent two of the four color-zones; the five color-zones simultaneously display within a same display frame.

2. The color-zone layout of light-emitting module according to claim 1, wherein the light-emitting zone unit comprises 20 blocks; by sequentially and cyclically counting the blocks in a direction from any one of the 20 blocks up, every four continuously arranged blocks respectively form the first color-zone, the second color-zone, the third color-zone and the fourth color-zone; a block is disposed between two adjacent ones of the above-mentioned four color-zones and the block is serving as the fifth color-zone.

3. The color-zone layout of light-emitting module according to claim 1, wherein the first color-zone, the second color-zone, the third color-zone and the fourth color-zone are respectively red, green, blue and white, and the fifth color-zone is black color-zone.

4. The color-zone layout of light-emitting module according to claim 1, wherein the first color-zone, the second color-zone, the third color-zone and the fourth color-zone are respectively yellow, cyan, magenta and white, and the fifth color-zone is black color-zone.

5. The color-zone layout of light-emitting module according to claim 1, wherein at least a light-emitting zone unit has a plurality of light-emitting zone units adjacently arranged.

6. The color-zone layout of light-emitting module according to claim 1, wherein at least a light-emitting zone unit is formed by five light-emitting zone units arranged continuously, wherein the two blocks of the fifth color-zone respectively located in adjacent two of the light-emitting zone units are shifted from each other by a block.

7. A color-zone layout of light-emitting module, comprising:
at least a light-emitting zone unit having a plurality of blocks, wherein the blocks, staring from any one block, are sequentially and cyclically arranged in a direction into a first color block, a second color block, a third color block, a fourth color block and a fifth color block, wherein the five color blocks comprise a black block and a white block.

8. The color-zone layout of light-emitting module according to claim 7, wherein the light-emitting zone unit comprises 20 blocks; from any one of the 20 blocks up, the blocks are sequentially and cyclically arranged in a direction into a first color block, a second color block, a third color block, a fourth color block and a fifth color block.

9. The color-zone layout of light-emitting module according to claim 7, wherein the first color block, the second color block, the third color block, the fourth color block and the fifth color block are respectively red, green, blue, white and black.

10. The color-zone layout of light-emitting module according to claim. 7, wherein the first color block, the second color block, the third color block, the fourth color block and the fifth color block are respectively yellow, cyan, magenta, white and black.

11. The color-zone layout of light-emitting module according to claim 7, wherein at least a light-emitting zone unit has a quantity of five.

12. A controlling method of color sequence, for controlling the light-emitting sequence of a backlight module and comprising:
dividing the backlight module into a plurality of regions;
defining the regions into a first light-emitting pattern, a second light-emitting pattern, a third light-emitting pattern, a fourth light-emitting pattern and a fifth light-emitting pattern, wherein each of the light-emitting patterns comprises a first color-zone, a second color-zone, a third color-zone, a fourth color-zone and a fifth color-zone, and the fifth color-zone separates the first color-zone, the second color-zone, the third color-zone and the fourth color-zone from each other;
taking the first light-emitting pattern, the second light-emitting pattern, the third light-emitting pattern, the fourth light-emitting pattern and the fifth light-emitting pattern as a light-emitting cycle and making the above-mentioned five light-emitting patterns sequentially lighten according to a time sequence,
wherein the five light-emitting patterns are designed to allow each of the light-emitting patterns to emit the color light of the first color-zone, the color light of the second color-zone, the color light of the third color-zone, the color light of the fourth color-zone and the color light of the fifth color-zone once each after completing the light-emitting cycle.

13. The controlling method of color sequence according to claim 12, wherein the total area of each of the five color-zones is equal to each other.

14. The controlling method of color sequence according to claim 12, wherein the total area of each of the five color-zones is not entirely equal to each other.

15. The controlling method of color sequence according to claim 12, wherein the first color-zone, the second color-zone, the third color-zone and the fourth color-zone are respectively red, green, blue and white, and the fifth color-zone is black zone.

16. The controlling method of color sequence according to claim 12, wherein the first color-zone, the second color-zone, the third color-zone and the fourth color-zone are respectively yellow, cyan, magenta and white, and the fifth color-zone is black zone.

17. The controlling method of color sequence according to claim 12, wherein the first light-emitting pattern, the second light-emitting pattern, the third light-emitting pattern, the fourth light-emitting pattern and the fifth light-emitting pattern are formed by dividing an original pattern into five equal portions and making the portions cyclically shifted.

18. The controlling method of color sequence according to claim 17, wherein the original pattern comprises at least a light-emitting zone unit; the light-emitting zone unit comprises 20 blocks; the blocks are sequentially and cyclically counted in a direction from any one of the 20 blocks up; every four continuous blocks respectively form a first color-zone, a second color-zone, a third color-zone and a fourth color-zone, and any two adjacent color-zones are separated by a block; the blocks for separation form a fifth color-zone.

19. The controlling method of color sequence according to claim 17, wherein the first color-zone, the second color-zone, the third color-zone and the fourth color-zone are respectively red, green, blue and white, and the fifth color-zone is black color-zone.

20. The controlling method of color sequence according to claim 17, wherein the first color-zone, the second color-zone, the third color-zone and the fourth color-zone are respectively yellow, cyan, magenta and white, and the fifth color-zone is black color-zone.

21. The controlling method of color sequence according to claim 17, wherein at least a light-emitting zone unit has a plurality of light-emitting zone units adjacently arranged.

22. The controlling method of color sequence according to claim 17, wherein at least a light-emitting zone unit is formed by five light-emitting zone units arranged continuously, wherein the two blocks of the fifth color-zone respectively located in two adjacent light-emitting zone units are shifted from each other by a block.
